(19) United States
(12) Patent Application Publication
(10) Pub. No.: US 2010/0300007 A1
(43) Pub. Date: Dec. 2, 2010

(54) STORM SHELTER AND COMPONENTS THEREOF

(76) Inventor: John F Bunts, SR., Dunnellon, FL (US)

Correspondence Address: LAW OFFICE OF STEVEN R. OLSEN, PLLC, P.O. BOX 2092, INVERNESS, FL, 34451-2092, US

(21) Appl. No.: 12/473,238

(22) Filed: May 27, 2009

(51) Int. Cl. E04H 9/14; E04D 13/00; E06B 3/30; E06B 7/14; E02D 29/14

(52) U.S. Cl. 52/11; 52/79.1; 52/204.5; 52/209; 52/20

(57) ABSTRACT

Embodiments of the invention provide a shelter with a ventilated storm window that can be affixed to an exterior wall of the shelter. The ventilated storm window can enable shelter occupants to safely view areas outside of the shelter. The ventilated storm window can also improve air circulation compared to roof-mounted ventilation schemes. Embodiments of the invention may also include a shelter with an improved hatch that can be mounted on a roof of the shelter. The hatch may be configured to withstand storm-force winds and torrential rains.

### BACKGROUND AND SUMMARY

1. Field of the Invention

The invention relates generally to building construction, and more particularly, but without limitation, to a storm shelter and components thereof.

2. Description of the Related Art

Tropical cyclones (a/k/a hurricanes or typhoons), tornados, and other high-energy storms can produce or be associated with strong winds and heavy rain. Flying debris can be a secondary consequence of the strong winds.

Shelters can provide a temporary refuge from damaging wind and rain. Known shelter designs have many shortcomings, however. For instance, conventional shelters typically employ roof-mounted ventilation. The roof-mounted ventilation is usually in either an inverted J pipe or mushroom head configuration. Such ventilation schemes may only provide for very limited air circulation inside the shelter, however. This is especially true where fans are not used in conjunction with such roof vents. Moreover, because of risk associated with flying debris, conventional shelters typically do not include windows. The absence of windows virtually eliminates the possibility of natural lighting. The lack of windows may also cause shelter occupants to feel enclosed and isolated. In addition, in conventional shelter design, human ingress and egress is typically through a steel pre-hung door or other wall-mounted door. But standard pedestrian doors may not be suited to in-ground, or partially in-ground, shelters. Hatches that might otherwise be useful for passage through a roof may not be suitably configured to operate in extreme wind and rain environments.

For at least the foregoing reasons, there is a need for improved shelter design.

### SUMMARY OF THE INVENTION

Embodiments of the invention seek to overcome one or more of the shortcomings described above with an improved shelter design. Accordingly, embodiments of the invention provide a shelter with a ventilated storm window that can be affixed to an exterior wall of the shelter. The ventilated storm window can enable shelter occupants to safely view areas external to the shelter. The ventilated storm window can also improve air circulation compared to roof-mounted ventilation schemes. Embodiments of the invention may also include a shelter with an improved hatch that can be mounted on a roof of the shelter. The hatch may be configured to withstand storm-force winds and torrential rains.

### BRIEF DESCRIPTION OF THE DRAWINGS

The present invention will be more fully understood from the detailed description below and the accompanying drawings, wherein:

FIG. 1 is a perspective view of shelter, according to an embodiment of the invention;

FIG. 2 is an exploded assembly view of the shelter in FIG. 1;

FIG. 3 is a perspective view of shelter, according to another embodiment of the invention;

FIG. 4 is a perspective view of a ventilated storm window, according to an embodiment of the invention;

FIG. 5 is an exploded assembly view of the ventilated storm window in FIG. 4;

FIG. 6 is a sectional view of the ventilated storm window in FIGS. 4 and 5;

FIG. 7 is a perspective view of a hatch in a closed position, according to an embodiment of the invention;

FIG. 8 is a perspective view of the hatch in FIG. 7 in an open position;

FIG. 9 is a sectional view of the hatch in FIG. 8 taken through line A-A;

FIG. 10 is a sectional view of the hatch in FIG. 7 taken through line B-B;

FIG. 11 is a sectional view of the hatch in FIG. 7 taken through line C-C in an unlatched condition; and

FIG. 12 is a sectional view of the hatch in FIG. 7 taken through line C-C in a latched condition.

### DETAILED DESCRIPTION

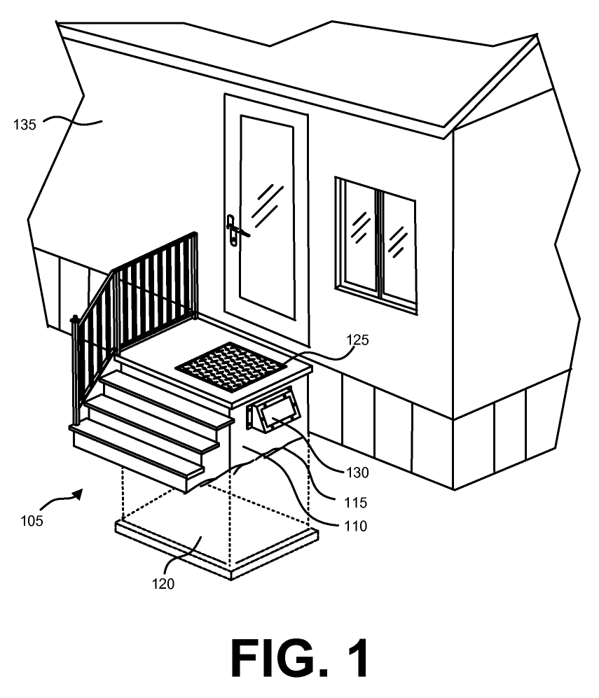

Embodiments of the invention will now be described more fully with reference to FIGS. 1-12, in which embodiments of the invention are shown. This invention may, however, be embodied in many different forms and should not be construed as limited to the embodiments set forth herein. In the figures, reference designators may be duplicated for the same or similar features. Features are not necessarily drawn to scale.

FIG. 1 is a perspective view of shelter, according to an embodiment of the invention. As shown therein, a shelter 105 may be configured as a porch and disposed adjacent to a building 135. The shelter 105 may include an above-grade portion 110 disposed above the grade 115 and a below-grade portion 120 disposed below the grade 115. The above-grade portion 110 and the below-grade portion 120 may be considered portions of the shell of the shelter 105. The shelter 105 may also include a hatch 125 to provide ingress into and egress from the shelter 105. The shelter 105 may further include a ventilated storm window 130. The building 135 may be or include, for instance, a mobile or modular home.

Variations to the embodiment illustrated in FIG. 1 are possible. For instance, the shelter 105 also may include at least one additional window 130 to facilitate ventilation in an interior of the shelter 105.

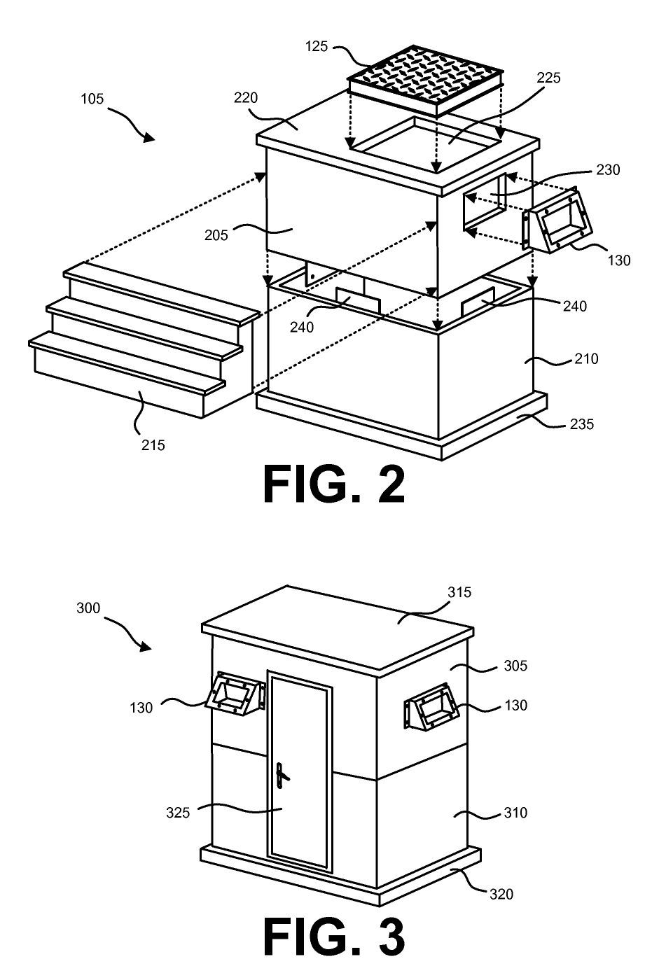

FIG. 2 is an exploded assembly view of the shelter in FIG. 1. As shown in FIG. 2, the shelter 105 may include an upper portion 205, and a lower portion 210. The upper portion 205 and the lower portion 210 may be considered the shell of the shelter 105. The upper portion 205 may include a top 220 and an opening 225 in the top 220. The top 220 may be integrally formed with the upper portion 205, for instance in a precasting operation. The opening 225 is configured to couple with the hatch 125. The upper portion 205 may further include an opening 230 in a wall. The opening 230 is configured to communicate with the ventilated storm window 130. The lower portion 210 may include a bottom 235. The bottom 235 may be integrally formed with the lower portion 210, for instance in a precasting operation. The bottom 235 may extend beyond side walls of the lower portion 210, as illustrated. The upper portion 205 may be joined to the lower portion 210 with an adhesive and/or sealant (not shown). The upper portion 205 may also be joined to the lower portion 210 using horizontal stabilization plates 240. Each of the horizontal stabilization plates 240 may be fastened to the upper portion 205 and the lower portion 210, for example via masonry anchor bolts (not shown) or other fasteners.

In one embodiment, the steps 215 may be rigidly attached to the upper portion 205 or another portion of the shelter 105. Alternatively, the steps 215 may simply be placed adjacent to the upper portion 205 or another portion of the shelter 105.

FIG. 3 is a perspective view of a shelter, according to another embodiment of the invention. As illustrated in FIG. 3, the shelter 300 may include an upper portion 305, and a lower portion 310. The upper portion 305 and the lower portion 310 may be considered the shell of the shelter 300. The upper portion 305 may include a top 315. The top 315 may be integrally formed with the upper portion 305, for instance in a precasting operation. The upper portion 305 includes two ventilated storm windows 130. The lower portion 310 may include a bottom 320. The bottom 320 may be integrally formed with the lower portion 310, for instance in a precasting operation. The bottom 320 may extend beyond side walls of the lower portion 310, as illustrated. The upper portion 305 may be joined to the lower portion 310 with an adhesive/sealant (not shown). The upper portion 305 may also be joined to the lower portion 310 using horizontal stabilization plates (not shown) as described above with reference to the shelter embodiment illustrated in FIG. 2. The shelter 300 also includes a pedestrian door 325.

Variations to the embodiment illustrated in FIG. 3 are possible. For instance, fewer or more ventilated storm windows 130 could be included in the shelter 300, according to design choice.

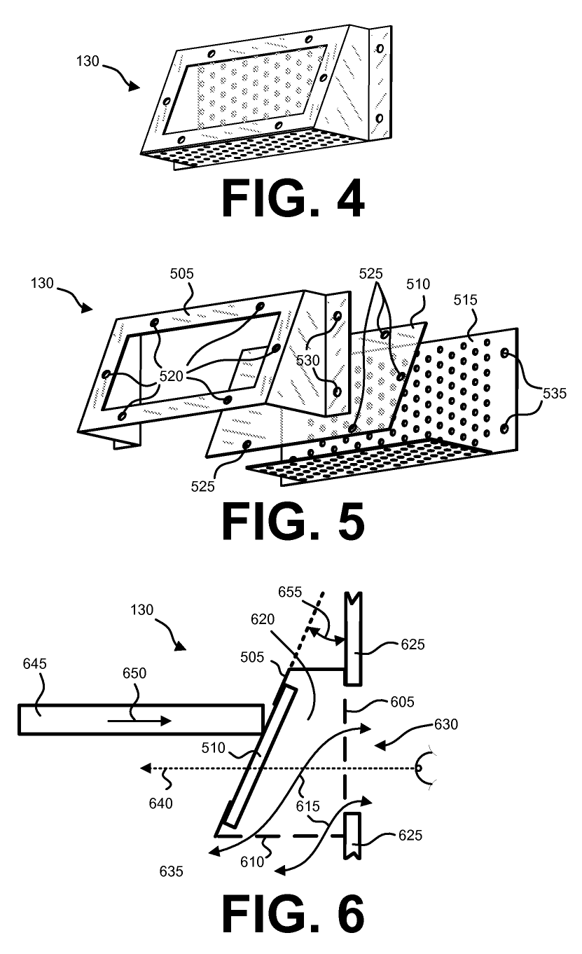

An embodiment of the ventilated storm window 130 introduced above is described in more detail with reference to FIGS. 4-6 below. FIG. 4 is a perspective view of a ventilated storm window, according to an embodiment of the invention. FIG. 5 is an exploded assembly view of the ventilated storm window in FIG. 4.

As illustrated in FIGS. 4 and 5, a ventilated storm window 130 includes a frame 505, a window pane 510 coupled to the frame 505, and a perforated screen 515 coupled to the frame 505. The frame 505 may be or include, for example, bent aluminum. The window pane 510 may be transparent and may be or include, for instance, a Lexan™ or other polymer sheet. The perforated screen 515 may be or include, for example, a single piece of perforated stainless steel.

Fasteners (not shown), fastener holes 520, and fastener holes 525 may be used to couple the window pane 510 to the frame 505. Additional fasteners (not shown), fastener holes 530, and fasteners holes 535 may be used to couple the perforated screen 535 to the frame 505.

FIG. 6 is a sectional view the ventilated storm window in FIGS. 4 and 5. The perforated screen 515 may include a side surface 605 and a bottom surface 610. The frame 505, window pane 510 and perforated screen 515 define an interior 620 of the ventilated storm window 130. The bottom surface 610 may advantageously prevent debris from entering the interior 620.

In FIG. 6, the ventilated storm window 130 is coupled to a wall 625. The wall 625 may be a portion of the shelter 105 or 300, for instance. There is an opening 630 in the wall 625, and the ventilated storm window 130 communicates with the opening 630.

Airflow paths 610 illustrate that there is fluid (e.g., air) communication between an outside area 635, the interior 620, and the opening 630. More specifically, there is fluid communication between the outside area 635 and the interior 620 of the ventilated storm window 130 via the bottom surface 610 of the perforated screen 515. In addition, there is fluid communication between the interior 620 of the ventilated storm window 130 and the opening 630 in the wall 625 via the side surface 605 of the perforated screen 515.

FIG. 6 also illustrates an exemplary visual path 640 through the side surface 605 of the perforated screen 515 and the window pane 510.

FIG. 6 further illustrates a projectile 645 moving in a direction 650 and contacting the ventilated storm window 130, as might occur during a tornado or other storm. One or more features of the ventilated storm window 130 may mitigate risks associated with the projectile 645. For example, in embodiments of the invention, the window pane 510 may be constructed of an impact-resistant material such as Lexan™. In addition, the window pane 510 may be disposed at an angle 655 with respect to the wall 625 to facilitate deflection of the projectile 645. Moreover, the side surface 605 of the perforated screen 515 may provide a secondary barrier to the projectile 645 if the projectile 645 breaches the window pane 510.

Variations to the embodiment illustrated in FIGS. 4-6 are possible. For instance, in an alternative embodiment, the window pane 510 may be translucent rather than transparent. In alternative embodiments, the perforated screen 515 may be replaced with meshed wire or another functionally equivalent screen that is configured to filter particles from the air while still permitting ventilation. In alternative embodiments, the functionally equivalent screen could include a first ventilation screen that is disposed at an angle with respect to a second ventilation screen rather than being formed from a single piece of material.

An embodiment of the hatch 125 introduced above is described in more detail below with reference to FIGS. 7-12.

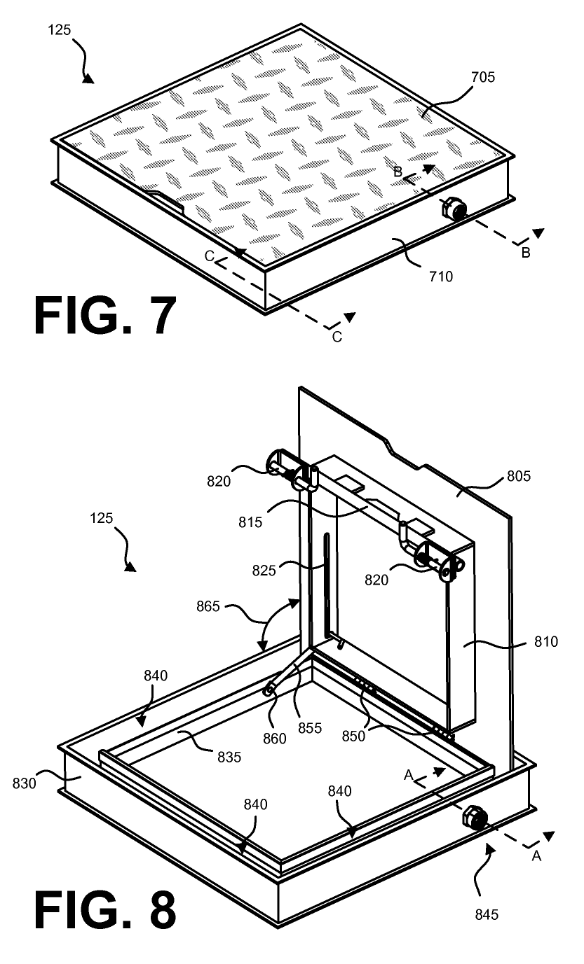

FIG. 7 is a perspective view of a hatch in a closed position, according to an embodiment of the invention. As therein, the hatch 125 includes a lid assembly 705 coupled to a frame assembly 710. FIG. 8 is a perspective view of the hatch in FIG. 7 in an open position. As illustrated in FIG. 8, the lid assembly 705 includes a lid 805, a flange 810 coupled to the lid 805, a mount 815 coupled to the flange 810, and two spring latches 820 coupled to the mount 815. The use of two spring latches 820 rather than one may be advantageous because there is safety in redundancy. Each component of the lid assembly 705 may be or include, for example, steel or aluminum.

The frame assembly 710 includes an outer wall 830, an inner wall 835, and a floor (not shown). A gutter 840 is formed by the outer wall 830, the inner wall 835 and the floor. A drain 845 is disposed in a portion of the outer wall 830.

The lid assembly 705 may be coupled to the frame assembly 710 via hinges 850. In addition, a retention arm 855 is coupled to the inner wall 835 at pivot point 860 and movably coupled to a slot 825 in the flange 810. In operation, the retention arm 855 may be used to hold the lid assembly 705 at an angle 865 with respect to the frame assembly 710.

Variations to the embodiment illustrated in FIG. 8 are possible. For instance, in an alternative embodiment, a single spring latch 820 may be used. Moreover, one or more latches other than a spring latch 820 may be used, according to design choice. In addition, the retention arm 855 and associated components could be eliminated. Alternatively, other hardware could be used to secure the lid assembly 705 in an open position.

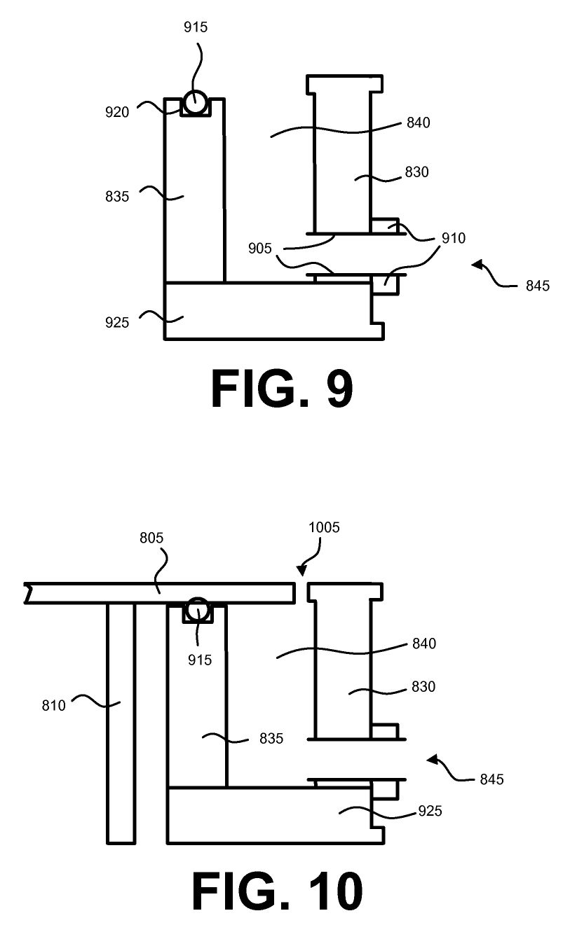

FIG. 9 is a sectional view of the hatch in FIG. 8 taken through line A-A. As shown therein, the gutter 840 is defined by the inner wall 835, outer wall 830 and floor 925. A drain 845 may be formed, for instance, by disposing a pipe 905 in a portion of the outer wall 830. The pipe 905 may optionally be secured by a collar 910. A slot 920 may be disposed on a top edge of the inner wall 835 to accept a gasket 915.

FIG. 10 is a sectional view of the hatch in FIG. 7 taken through line B-B. In FIG. 10, the hatch 125 is shown in a closed position. The lid 805 communicates with the gasket 915 to seal the lid assembly 705 to the frame assembly 710. Even in this closed position, however, there exists a gap 1005 through which rain water (not shown) can enter into the gutter 840. In operation, the gutter 840 will channel any such rain water and allow the rain water to empty from the gutter 840 via the drain 845.

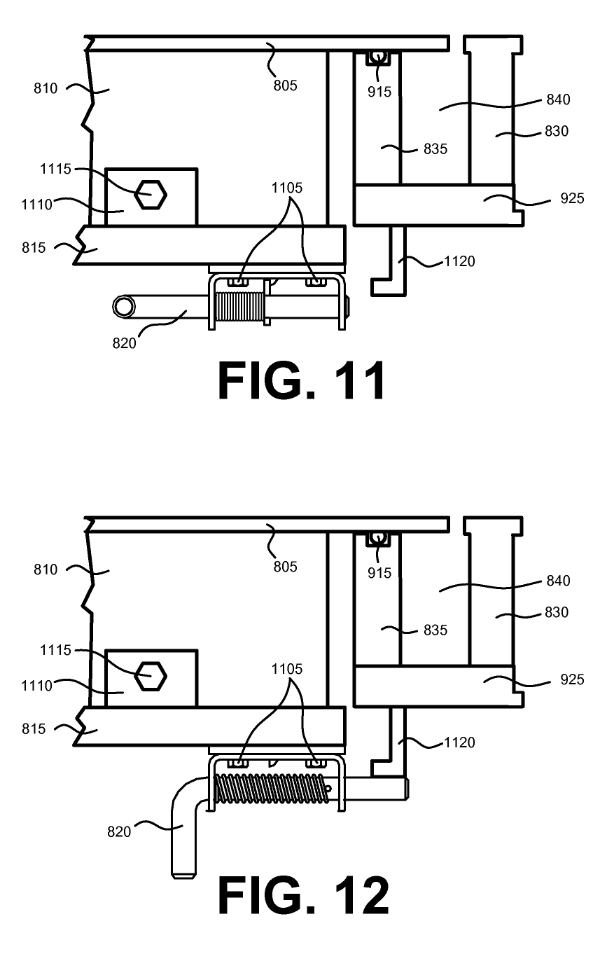

FIG. 11 is a sectional view of the hatch in FIG. 7 taken through line C-C in an unlatched condition. As shown therein, the spring latch 820 is coupled to the mount 815 via bolts 1105. The mount 815 may be or include, for instance, a section of piping. A tab 1110 may be coupled to the mount 815, for instance via a weld joint. The tab 1110 may be coupled to the flange 810 with the bolt 1115.

FIG. 12 is a sectional view of the hatch in FIG. 7 taken through line C-C in a latched condition. As shown therein, the spring latch 820 is configured to engage with a riser 1120 in the latched condition. In operation, pressure must be applied to open the spring latch. A release of pressure locks the lid assembly 705 to the frame assembly 710.

It will be apparent to those skilled in the art that modifications and variations can be made without deviating from the spirit or scope of the invention. For example, alternative features described herein could be combined in ways not explicitly illustrated or disclosed. Thus, it is intended that the present invention cover any such modifications and variations of this invention provided they come within the scope of the appended claims and their equivalents.

I claim:

1. A shelter comprising:
a shell having a wall; and
a ventilated storm window assembly coupled to the wall, the ventilated storm window assembly including
a window frame coupled to the wall,
an impact-resistant window pane attached to the window frame such that the impact-resistant window frame is disposed at an angle with respect to the wall, and
a ventilation screen coupled to the window frame, the ventilation screen including
a first vented surface configured to allow fluid communication between an opening in the wall and an interior of the window frame, and
a second vented surface configured to provide fluid communication between the interior of the window frame and ambient air below the window frame.

2. The shelter of claim 1, wherein the impact-resistant window pane is transparent.

3. The shelter of claim 1, wherein the impact-resistant window pane is translucent.

4. The shelter of claim 1, wherein the ventilation screen includes perforated steel.

5. The shelter of claim 1, wherein the ventilation screen includes wire mesh.

6. The shelter of claim 1, wherein the first vented surface and the second vented surface are formed from a single piece of material.

7. The shelter of claim 1, further comprising a pedestrian door coupled to the shell.

8. The shelter of claim 1, wherein the shell includes an upper shell portion coupled to a lower shell portion.

9. The shelter of claim 1, wherein the shell includes a roof, the shelter further comprising a hatch coupled to the roof, the hatch including:
a lid assembly; and
a frame assembly coupled to the lid assembly, the frame assembly having:
a gutter configured to collect rainwater; and
a drain coupled to the gutter, the drain configured to vacate the rainwater from the gutter.

10. The shelter of claim 9, wherein the lid assembly is coupled to the frame assembly by at least one hinge and at least one retention arm.

11. The shelter of claim 9, wherein the lid assembly includes at least one spring latch, the at least one spring latch configured to require pressure to retract from a riser, the spring latch configured to engage the riser when pressure is released.

12. The shelter of claim 9, further comprising steps coupled to the shell.

13. A ventilated storm window assembly configured to be mounted on wall, the ventilated storm window comprising:
a means for supporting coupled to the wall;
a means for viewing through the ventilated storm window coupled to the means for supporting; and
a means for double ventilation through the ventilated storm window coupled to the means for supporting.

14. A hatch comprising:
a lid assembly; and
a frame assembly coupled to the lid assembly, the frame assembly having:
a gutter configured to collect rainwater; and
a drain coupled to the gutter, the drain configured to vacate the rainwater from the gutter.

15. The hatch of claim 14 wherein the hatch lid assembly includes:
a lid;
a flange coupled to a bottom side of the lid; and
at least one spring latch coupled to the flange.

16. The hatch of claim 15 wherein the flange includes a slot, the hatch including a retention arm coupled to the slot and the hatch frame assembly.

17. The hatch of claim 14 wherein the hatch lid assembly includes a lid, the frame assembly including an inner wall, the inner wall including a slot on a top surface of the inner wall, a gasket being disposed in the slot, the gasket configured to contact the lid when the hatch is in a closed configuration.
